(19) United States
(12) Patent Application Publication
(10) Pub. No.: US 2006/0137937 A1
(43) Pub. Date: Jun. 29, 2006

(54) DETACHABLE UTILITY SHELF

(76) Inventor: Carol Pratt, Dearborn, MI (US)

Correspondence Address: DICKINSON WRIGHT PLLC, 1901 L. STREET NW, SUITE 800, WASHINGTON, DC, 20036, US

(21) Appl. No.: 10/905,344

(22) Filed: Dec. 29, 2004

(51) Int. Cl. E06C 5/32

(52) U.S. Cl. 182/129

(57) ABSTRACT

An adjustable utility shelf having a level work area and a secure means of carrying and storing small objects configured for attachment to a ladder. The utility shelf includes a housing, a pair of brackets at secure to an object such as a ladder, and a pair of extendable arms configured to receive large rolls of spooled items such as tape, paper towels, and the like, while folding horizontal and adjacent the sides of the housing to allow convenient storage while not in use. The housing may have a plurality of partitions that are attached to the base floor forming compartments and may have a lid configured to secure and store its contents. The compartment floors may be sloped to allow easy removal of contents, or magnetized to secure metal objects during transport or storage.

### FIELD OF INVENTION

The present invention generally relates to utility shelves, and more particularly, to a detachable multi-purpose utility shelf configured for attachment to the top of a step ladder.

### BACKGROUND OF INVENTION

People who work from step ladders frequently have difficulty managing items they require for completing tasks. The user is often required to make frequent trips down and up the ladder to retrieve these items due to the lack of convenient and secure storage for such items. Attempts are known in the art to solve these problems using various storage devices that may be attached to a ladder. For example, see U.S. Pat. No. 4,949,925 to Gorecki. Unfortunately, the simple nature of this invention makes it impractical for use for a variety of tasks. U.S. Pat. No. 4,706,918 to Wison discloses an accessory to hang on a ladder rung, but it places two receptacles on each side of the ladder. This cumbersome design is also impractical.

Compartments have also been attempted in these types of shelves. See U.S. Pat. No. 4,730,802 to Chatham and U.S. Pat. No. 361,664 to Brown. Unfortunately, they do not provide a means to secure small items that may be carried within its compartments or any other features that would allow the ability to secure larger items such as rolls of paper towels.

Other inventions, such as U.S. Pat. No. 4,480,810 to Hall and U.S. Pat. No. 5,542,553 to Penniman, involve ladder caddies that incorporate apertures for hanging tools but do not leave any room for larger items such as paint cans nor do they provide compartments to secure small items.

Thus, there is a desire and a need in the art to provide improvements to utility shelves configured for attachment to ladders to make them not only more effective, but also to solve the problems associated with securing small and large items.

### SUMMARY OF THE INVENTION

Accordingly, it is an important aspect of the invention to provide a level work area and a secure means of carrying and storing small objects.

The present invention relates generally to portable, adjustable utility shelves, and more particularly, a detachable, multi-purpose utility shelf configured for attachment to a ladder. Specifically, the present invention utility shelf includes a housing, a pair of brackets, and a pair of extendable arms configured to receive large rolls of spooled items such as tape, paper towels, and the like, while folding against the sides of the housing to allow convenient storage while not in use.

The housing of the present invention includes a base floor, first sidewall and second sidewall, each having an interior and exterior surface, a front wall, and a back wall. The base floor may include apertures configured to receive a plurality of objects such as cups, hammer, screwdriver, pliers, and the like. A pair of brackets attach to the housing, each having an armature slidably attached to the exterior surfaces of the back wall and base floor of the housing. The brackets have a distal end with means to secure the shelf to a stationary object such as a ladder. The brackets provide a level and secure support for the shelf.

The housing may have a plurality of partitions that are attached to the base floor forming compartments and may have a lid configured to secure and store small objects such as nails, tacks, screws, drill bits and the like. The lid may be secured by a closing mechanism such as a hasp or a snap element provided on the upper edge area of the container for the lid to snap onto. The lid would have an area in tight contact with the container's upper edge area. The compartments and lids may be made in numerous configurations and still fall within the scope of the invention. The compartment floors may be sloped to allow easy removal of contents, or magnetized to secure metal objects during transport or storage.

Other features of the present invention will become more apparent to persons having ordinary skill in the art to which the present invention pertains from the following description and claims taken in conjunction with the accompanying figures.

### BRIEF DESCRIPTION OF THE FIGURES

The foregoing features, as well as other features, will become apparent with reference to the description and figures below, in which like numerals represent like elements, and in which:

FIG. 1 is a side perspective view of a detachable utility shelf;

FIG. 2 is side perspective view of a detachable utility shelf with a plurality of lids;

FIG. 3 is a side perspective view of an alternate embodiment of a detachable utility shelf with compartments attached to the front wall;

FIG. 4 is a side perspective view of a detachable utility shelf with compartments attached to the front wall with a plurality of lids;

FIG. 5 is a top view of a detachable utility shelf; and

FIG. 6 is an end perspective view of a detachable utility shelf showing adjustable attachment brackets.

### DETAILED DESCRIPTION

There exist in the art several types of utility shelves for structures such as a ladder. Unfortunately, these devices do not provide an adequate means to secure many useful items. The present invention provides an adjustable utility shelf having a level work area and a secure means of carrying and storing small objects such as spooled items, nails, nuts, bolts, screws, drill bits, rolls of paper towels, paint, drinks, power tools, hand tools, trash, or any of a virtually unlimited variety of other items needed by ladder users.

The present invention is a detachable multi-purpose utility shelf designed to be attached to the top or rung of a ladder or the like to provide a user an easily accessible, convenient work surface. The present invention may provide such features as compartments with lids for securing small items and arms configured to hold spooled items such as rolls of paper towels or tape. The invention provides a more secure and practical design since the lids may be closed to store items and pivotable arms to fold down against the device when not in use. The present invention may also serve as a base for other types of attachment accessories previously known in the art such as cup holders or baskets.

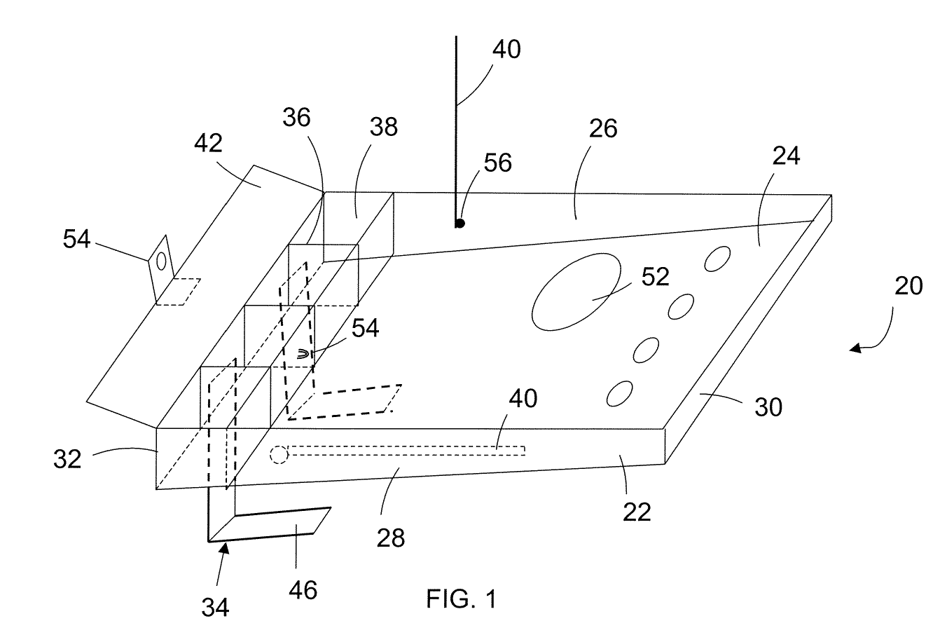

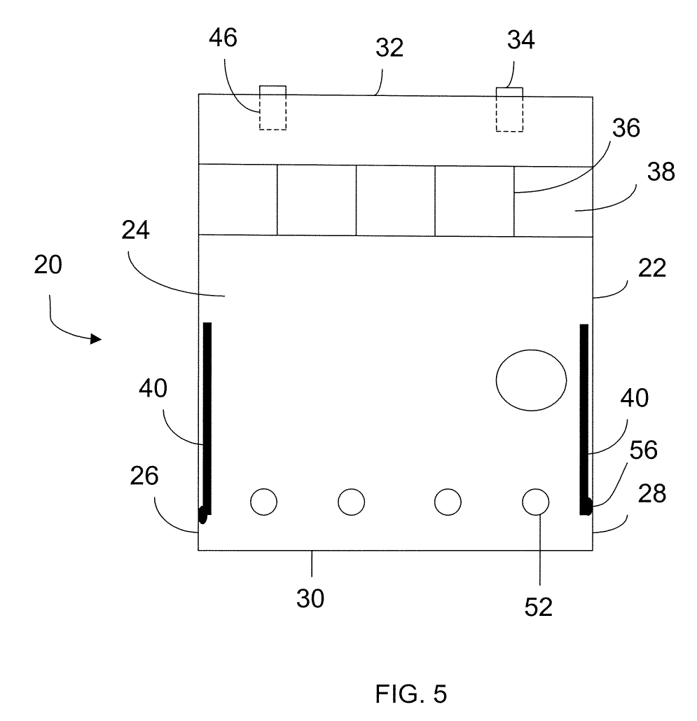

Referring now to the figures, FIGS. 1-6 show two possible embodiments of the present invention detachable utility shelf generally indicated at 20. It is noted that several other embodiments and configurations are possible and fall within the scope of the invention. Utility shelf 20 may be made from a variety of materials known in the art such as wood, molded plastic, metal, steel, aluminum or other suitable material. As best shown in FIGS. 1-4, housing 22 has a base floor 24, a first sidewall 26 with an interior and exterior surface, a second sidewall 28 with an interior and exterior surface, a front wall 30 with an interior and exterior surface, and a back wall 32 with an interior and exterior surface.

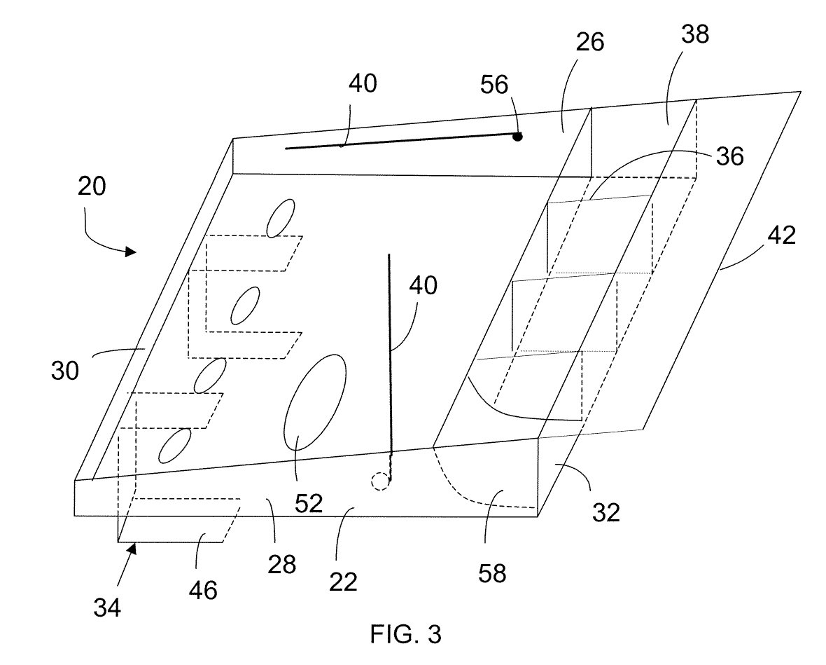

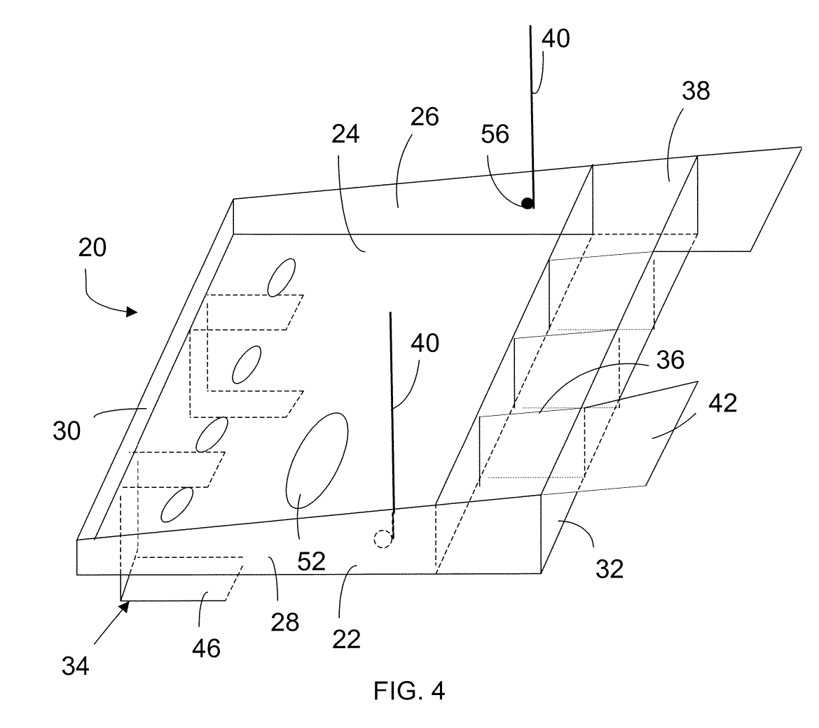

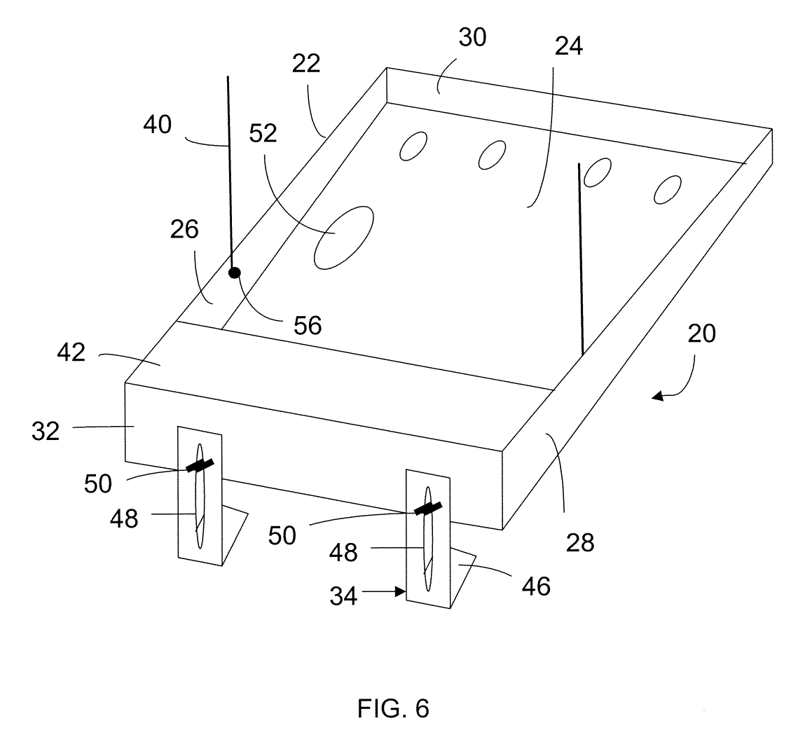

Pair of brackets 34 are configured to secure utility shelf 20 to an object such as a step ladder (not shown). As shown, each bracket 34 has an armature 46 slideably attached to back wall 32 or to base floor 24 (not shown). In an alternate embodiment, as shown in FIG. 3 and FIG. 4, brackets 34 will be attached to front wall 30. Many types of sliding mechanisms are possible, but as shown best in FIG. 6, a sliding mechanism includes a slot 48 through which a clamping device 50, such as a nut and bolt attached to back wall 32, may extend. For example, in use, clamping device 50 is loosened and utility shelf 20 is placed on the top step of a step ladder where the distal end of bracket armature 46 is slid under the top step of the step ladder. The user would then slide brackets 34 so that the distal end of bracket armature 46 and underside of base floor 24 are securely adjacent the bottom and top of the top step of a step ladder respectively. The user would then secure the utility shelf 20 to the ladder using clamping device 50 by, for example, tightening the nut (such as a “wing” nut) until it is tightly clamped against back wall 32 and thus holding the utility shelf 20 adjacent and secured to the step ladder.

The present invention provides a variety of means to hold and secure useful items needed by a user while on a step ladder. For example, as shown best in FIGS. 1-5, base floor 24 may have at least one aperture 52 configured to receive items such as a cup, hammer, screwdriver, pliers, and the like. Also, utility shelf 20 may have at least one compartment 38. Compartments 38 allow secure organization and storage of items such as nails and screws. Compartment 38 may be further divided using a plurality of partitions 36 that are attached to base floor 24. As shown in FIG. 3, compartment 38 may optionally have an upward sloping floor 58 to allow easy removal of contents similar to that found in a change drawer of a cash register. Sloping floor 58, or any area of the present invention where metal parts may be housed, may be made of a magnetic material to better secure its contents during transport or when not in use.

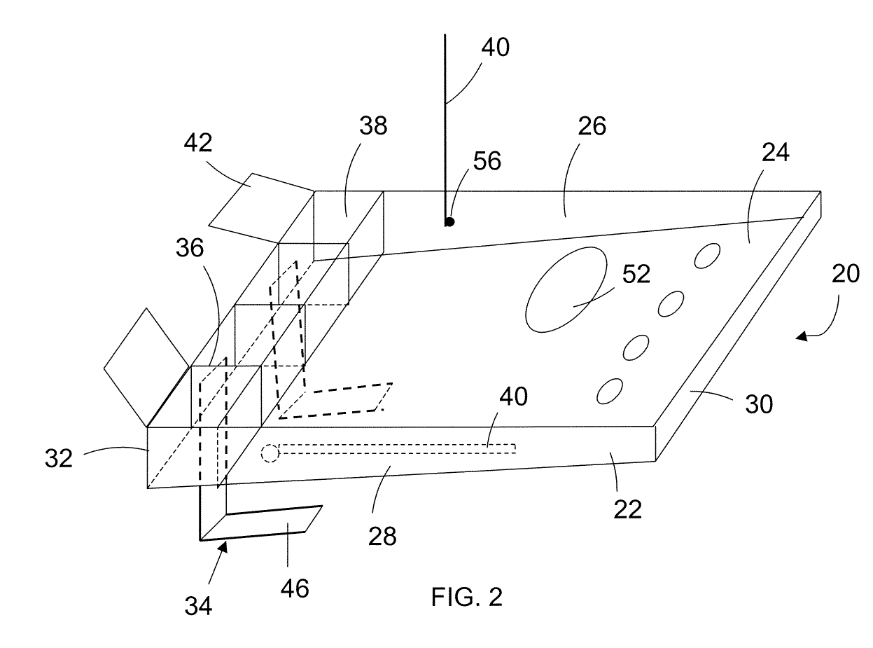

Optionally, compartments 38 may have one uniform lid 42 as shown in FIG. 1 or a plurality of lids 42 as shown in FIG. 2 that are hingedly attached to a top edge of compartments 38. Lid 42 may also have a securing mechanism, such as hasp 54 as shown in FIG. 1 or a snap element provided on the upper edge area of the compartment 38 for lid 42 to snap onto, lid 42 having an area in tight contact with compartment 38's top edge. As an additional option, at least one pivotal arm 40 may also be included to allow secure placement of spooled items such as rolls of paper towels, tape, wall paper, and the like. As shown, arms 40 are positioned on the interior surface of each sidewall with a pivoting means 56 allowing arm 40 to move from a first horizontal position parallel and adjacent to side wall 26 or 28 for storage to a second extended position during use as best shown in FIG. 3.

While the invention has been described in conjunction with specific embodiments, it is evident that many alternatives, modifications and variations will be apparent to those skilled in the art in light of the foregoing description. Accordingly, the present invention attempts to embrace all such alternatives, modifications and variations that fall within the spirit and scope of the appended claims.

What is claimed is:

1. A detachable utility shelf, comprising:
a housing having a base floor, a first sidewall having an interior and exterior surface, a second sidewall having an interior and exterior surface, a front wall, and a back wall;
a pair of brackets, each bracket having an armature slidably attached to said exterior surface of said back wall, said bracket further having a distal end with means to secure said shelf to a stationary object;
at least one aperture in said base floor;
a plurality of partitions attached to said base floor defining compartments; and
at least one arm pivotably attached to said interior surface of each side wall.

2. The shelf of claim 1, constructed of a high-impact resistant plastic material.

3. The shelf of claim 1, wherein the distal end of the armature is configured for attachment to a ladder rung.

4. The shelf of claim 1, wherein said compartments further comprise a lid hingedly attached to an edge of said plurality of partitions.

5. The shelf of claim 4, wherein said lid has a securing mechanism.

6. The shelf of claim 5, wherein said securing mechanism is a hasp.

7. The shelf of claim 1, wherein said arms pivot from a first horizontal position parallel and adjacent to a side wall to a second extended position.

8. The shelf of claim 1, wherein the compartments further comprise an upward sloping floor.

9. The shelf of claim 1, wherein the compartments further comprise a floor made of a magnetic material.
